(19) United States
(12) Patent Application Publication
(10) Pub. No.: US 2012/0020281 A1
(43) Pub. Date: Jan. 26, 2012

(54) METHOD FOR CHANGING MODULATION SCHEME AND BASE STATION APPARATUS USING SAID METHOD

(75) Inventor: Sakiko Nakamura, Gifu (JP)

(73) Assignee: Kyocera Corporation, Kyoto (JP)

(21) Appl. No.: 12/746,494

(22) PCT Filed: Dec. 4, 2008
(86) PCT No.: PCT/JP2008/003603

§ 371 Date: Nov. 4, 2010

(30) Foreign Application Priority Data
Dec. 6, 2007 (JP) 2007-315423

(51) Int. Cl. H04W 4/00

(52) U.S. Cl. 370/328

(57) ABSTRACT

An EVM measurement unit measures the EVM of received signals, and performs a weighted average on them so as to derive MSE. A frequency acquiring unit acquires the change frequency of modulation scheme and the occurrence frequency of data retransmission. A moving status acquiring unit acquires the variation situation in moving velocity of a terminal apparatus or positional relationship between a base station apparatus and the terminal apparatus. A threshold modifying unit determines the modulation scheme used for the next communication, based on the value of MSE and other pieces of information described above.

### TECHNICAL FIELD

The present invention relates to a technology by which to change a modulation scheme and more particularly to a method for changing the modulation scheme during a communication and a base station apparatus using said method.

### BACKGROUND TECHNOLOGY

In a movable communication system such as PHS (Personal Handyphone System), the transmission characteristics sometimes vary with time. One technique to improve the transmission efficiency under such a propagation environment is an adaptive modulation technique. The adaptive modulation technique estimates the transmission characteristics based on a parameter related to the quality of received signals, such as EVM (Error Vector Magnitude) used to evaluate the distortion of received signals. In the adaptive modulation technique, if it is estimated that the transmission characteristics are satisfactory, a modulation scheme capable of transporting a large amount of information (e.g., a modulation scheme having a large multi-level number) is used so as to increase the transmission rate. Also, if it is estimated that the transmission characteristics are not desirable, a modulation scheme whose transportable amount of information is small (e.g., a modulation scheme having a small multi-level number) is used so as to enhance the reliability.

In a PHS where a frame is formed using 4-slot multiplexing TDMA-TDD (Time Division Multiple Access—Time Division Duplex) scheme, a unique word by which to estimate the transmission characteristics and modulation-scheme information indicating a modulation scheme to be used are included in each time slot.

A base station apparatus estimates the transmission characteristics by use of a preamble included in a time slot of received signal, and a modulation scheme to be used is determined based on this estimation result (See Patent Document 1, for instance).
[Patent Document 1] Japanese Patent Publication No. 2004-56499.

### DISCLOSURE OF THE INVENTION

### Problems to be Solved by the Invention

In the conventional technique, when the transmission characteristics are to be estimated using EVM, a weighted moving average is obtained by multiplying the current estimate value and previous estimate value by a predetermined constant so as to smooth out the variation in the estimate value caused by a temporary factor. However, the processing of weighted moving average is sometimes unable to suppress the variation in the estimate value, depending on a propagation environment. In such a case, the modulation scheme is likely to be changed frequently in a short period of time.

When the modulation scheme is changed frequently, a plurality of signals need to be transmitted and received between a base station apparatus and a terminal apparatus and therefore the frequent change of modulation scheme causes a drop in transmission efficiency.

Although the processing of weighted moving average raises the stability of estimate value, the following capability drops and therefore the modulation best suited to the propagation environment is not always used. The use of a modulation scheme not suited to the propagation environment causes error in transmitted data and may require the retransmission of data.

As the data is retransmitted, a delay of a few frames or more is caused and therefore the use of a modulation scheme not suitable for the propagation environment also leads to reducing the transmission efficiency.

The present invention has been made in view of the foregoing circumstances, and a purpose thereof is to provide a base station apparatus capable of changing the modulation scheme to one suitable for a propagation environment.

### Means for Solving the Problems

One embodiment of the present invention relates to a base station apparatus. The base station apparatus comprises: a communication unit configured to communicate with a terminal apparatus; a first acquiring unit configured to acquire first information related to the quality of signal received by the communication unit; a second acquiring unit configured to acquire second information related to the change frequency of modulation scheme or the occurrence frequency of data retransmission between the base station apparatus and the terminal apparatus in a predetermined period of time; a third acquiring unit configured to acquire third information related to the moving status of the terminal apparatus; and a selector configured to select a modulation scheme used in a communication between the base station apparatus and the terminal apparatus, based on at least one of the first information, the second information and the third information.

Also, it is preferable that the selector select the modulation scheme used in a communication between the base station apparatus and the terminal apparatus, based on the first information and the second information.

Also, it is preferable that the third acquiring unit acquire the variation situation in moving velocity of the terminal apparatus or positional relationship between the base station apparatus and the terminal apparatus, as the third information. Also, the base station apparatus may further comprise a modifying unit configured to modify a threshold value related to the first information, based on the second or third information, and it is preferable that the selector select a modulation scheme used in a communication between the base station apparatus and the terminal apparatus, based on a result of comparing the first information against the threshold value.

Also, when it is determined that a modulation scheme having a multi-level number smaller than that of the selected modulation scheme is suitable for a communication between the base station and the terminal apparatus, the modifying unit preferably modifies the threshold value in such a manner that the modulation scheme having a smaller multi-level number is more likely to be selected in the selector; when it is determined that a modulation scheme having a multi-level number larger than that of the selected modulation scheme is suitable for the communication between the base station and the terminal apparatus, the modifying unit preferably modifies the threshold value in such a manner that the modulation scheme having a larger multi-level number is more likely to be selected in the selector.

### Effect of the Invention

The present invention determines a modulation scheme to be used, in consideration of not only the quality of received signals but also the frequency at which control signals are transmitted to and received from a terminal apparatus, and so forth. Thus the modulation scheme suited to the propagation environment can be accurately selected.

### BRIEF DESCRIPTION OF THE DRAWINGS

FIG. 1 is a conceptual diagram showing a structure of TDMA frame.

FIG. 2 is a conceptual diagram showing a structure of time slot.

FIG. 3 is a conceptual diagram showing a structure of a communication system according to an embodiment of the present invention.

FIG. 4 is a conceptual diagram showing a structure of a base station apparatus according to an embodiment of the present invention.

FIG. 5 is a conceptual diagram showing a data structure of a modulation-scheme table.

FIG. 6 is a conceptual diagram showing a transition of strictly-set threshold values.

FIG. 7 is a conceptual diagram showing a transition of loosely-set threshold values.

FIG. 8 is a flowchart showing a procedure for modifying threshold values.

FIG. 9 is a flowchart showing a procedure for modifying threshold values.

FIG. 10 is a sequence diagram showing a processing of changing a modulation scheme led by a base station apparatus 1.

### DESCRIPTION OF THE REFERENCE NUMERALS

101 Radio unit
102 Modem unit
103 IF unit
104 Control unit
1041 EVM measurement unit
1042 Frequency acquiring unit
1043 Moving status acquiring unit
1044 Recording unit
1045 Threshold modifying unit
1046 Modulation-demodulation determining unit
2092 Channel utilization calculating unit

### BEST MODE FOR CARRYING OUT THE INVENTION

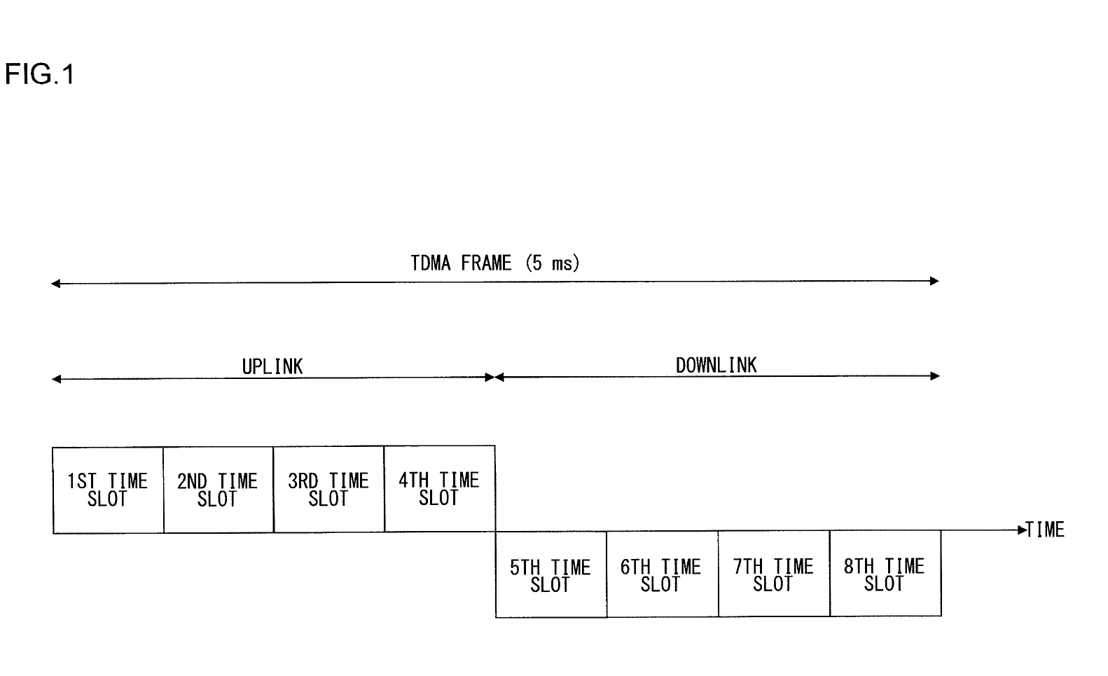

The present invention will be first outlined before the specifics thereof are explained. The embodiments of the invention relate to a base station apparatus using the TDMA-TDD method as with a second-generation cordless phone system. As shown in FIG. 1, in the second-generation cordless phone system, a TDMA frame, which will be hereinafter referred to as “frame”, is composed of four time slots for uplink communication (from a terminal apparatus to the base station apparatus) and four time slots for downlink communication (from the base station to the terminal apparatus), and frames are assigned contiguously. Since the uplink communication and the downlink communication are symmetrical to each other in the present embodiment, a description will be hereinbelow given of the downlink communication only, for convenience of explanation.

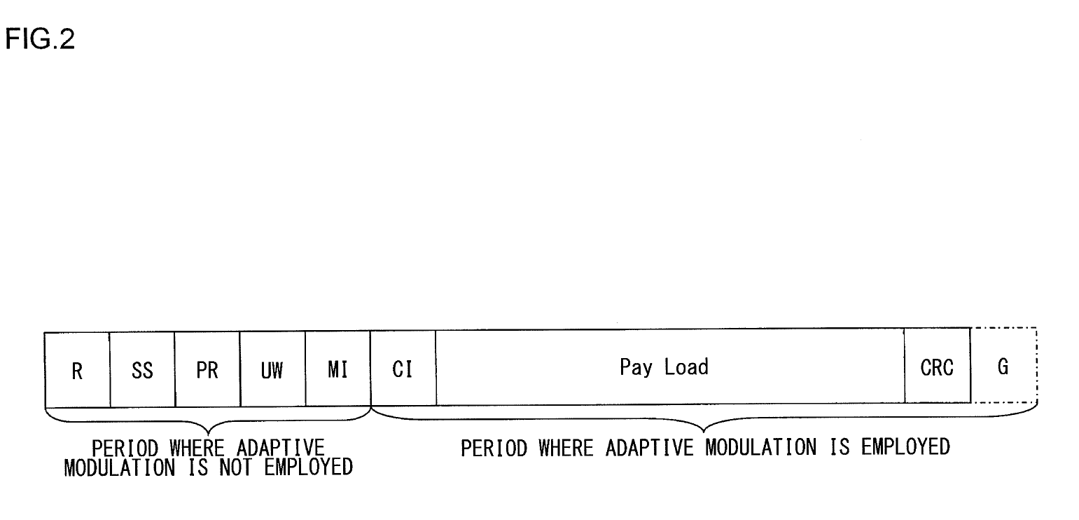

As shown in FIG. 2, each frame is constituted by an area where a modulation scheme is changed according to a propagation environment (hereinafter referred to as “adaptive modulation area”) and an area where the modulation scheme is not changed irrespective of the propagation environment (hereinafter referred to as “non-adaptive modulation area”). The non-adaptive modulation area is constituted by a ramp (R) used to ramp at turn-on and turn-off, a start symbol (SS), a preamble (PR), a synchronization word (UW), and a modulation parameter (MI). The non-adaptive modulation area is also constituted by a channel type CI ramp session (R), a start symbol (SS), a preamble (PR), a unique word (UW), and modulation-scheme information (MI). The adaptive modulation area is constituted by a channel type (CI), a data payload (Payload), an error-detecting code (CRC: Cyclic Redundancy Check), and a guard symbol (G) used to prevent the interference between adjacent time slots.

Using known signals such as UWs, the base station apparatus measures a distance between the coordinate point of an ideal known signal and that of a received known signal on the plane of I-Q coordinates where an in-phase component of signal and a quadrature-phase component represent their respective coordinate axes. Note that the measured distance therebetweeen is equal to the EVM. This measurement result is subjected to the processing of the weighted moving average so as to calculate a modulation parameter decision value (MSE: Mean Square Error).

The base station apparatus records threshold values related to the modulation parameter decision values, for each modulation scheme, and compares the calculated modulation parameter decision value against these threshold values so as to determine a modulation scheme to be used. At this time, if the propagation environment changes rapidly, the modulation parameter decision value may be affected thereby. Thus, there are cases where the modulation scheme is changed frequently even if the measured values of EVM have been subjected to the processing of weighted moving average. Also, the modulation parameter decision value is calculated by subjecting the measure values of EVM to the processing of weight moving average. As a result, the following capability in response to the change in the propagation environment drops and therefore the modulation scheme not suited to the propagation environment is sometimes selected. If a modulation scheme capable of transmitting a larger amount of information than a modulation scheme ideal for the actual propagation environment is selected, there may be cases where data cannot be transmitted with high reliability and the data retransmission occurs frequently.

In order to change the modulation scheme, a plurality of control signals, such as a signal requesting the switching of a modulation scheme, a signal instructing the switching of a modulation scheme and an idle burst, must be transmitted and received. Also, in order to retransmit data, a plurality of other control signals, such as a signal requesting the retransmission of data and a signal storing the data, must be transmitted and received.

In this manner, in order to change the modulation scheme and retransmit the data, a plurality of control signals must be transmitted and received between the base station apparatus and a terminal apparatus. Thus frequent change of modulation scheme and the frequent data retransmission lead to reducing the transmission efficiency.

The moving status of the terminal apparatus may not be reflected in the measured results of EVM. The moving status thereof includes, for example, a case where the terminal apparatus is barely moving and a case where it moves closer to the base station apparatus. Accordingly, when only the modulation parameter decision value obtained based on the measurement values of EVM is to be referenced, there is a chance that a modulation scheme whose transferrable amount of information is smaller than a modulation scheme ideal for the actual propagation environment will be selected. In such a case, the data transmission efficiency may drop.

Thus, in the base station apparatus according to the present embodiment, the modulation scheme used in communications between the base station apparatus and the terminal apparatus is determined in the following manner. That is, the modulation scheme is determined in consideration of not only the quality of signals received from the terminal apparatus but also the frequency at which the control signals are transmitted and received between the base station apparatus and the terminal apparatus and the moving status of the terminal apparatus. This can accurately select the modulation scheme suitable for the propagation environment.

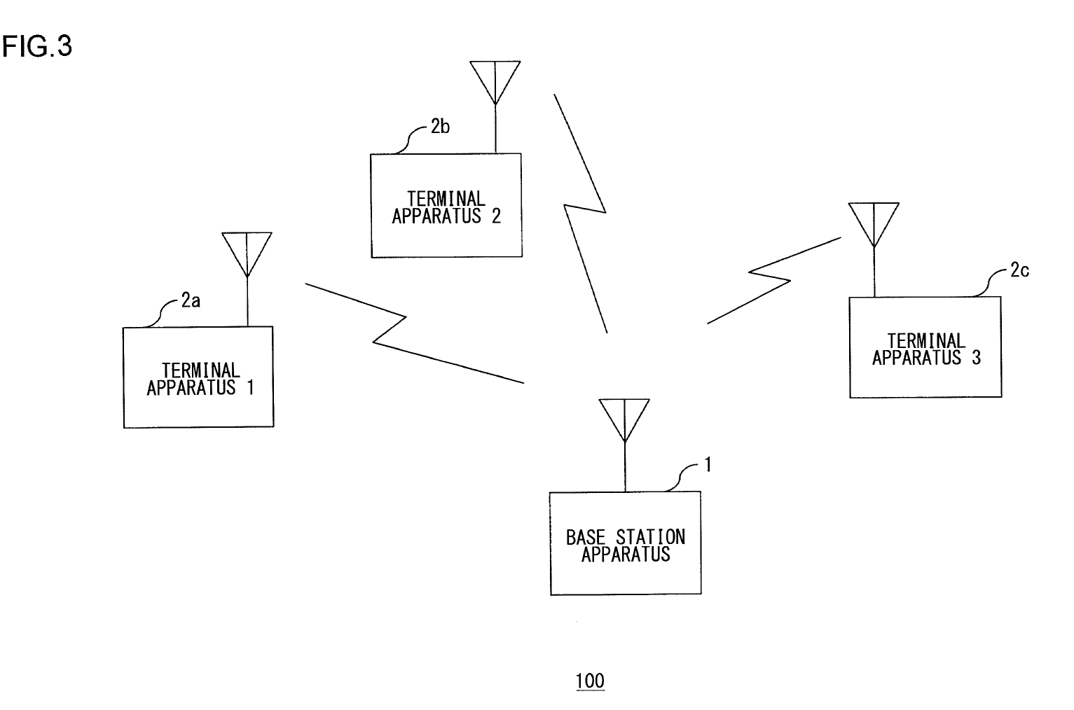

FIG. 3 is a conceptual diagram showing a structure of a communication system 100 according to a first embodiment of the present invention. A mobile communication system includes a base station apparatus 1 and a terminal apparatus 2. Though FIG. 3 shows three terminal apparatuses, namely a first terminal apparatus 2a, a second terminal apparatus terminal 2b, and a third terminal apparatus 2c, which are generically referred to as “terminal apparatus 2” or “terminal apparatuses 2”, there may be one or two terminal apparatuses or four or more terminal apparatuses.

The base station apparatus 1 has one end thereof connected to the terminal apparatus 2 via a wireless network and the other end thereof connected to a not-shown wired network. The terminal apparatus 2 connects to the base station apparatus 1 via a wireless network. The base station apparatus 1 performs communications with a plurality of terminal apparatuses 2 by assigning time slots to the plurality of terminal apparatuses 2. More specifically, the terminal apparatus 2 transmits a request signal for radio resource assignment to the base station apparatus 1 and in response to the request signal received, the base station apparatus 1 assigns a time slot to the terminal apparatus 2.

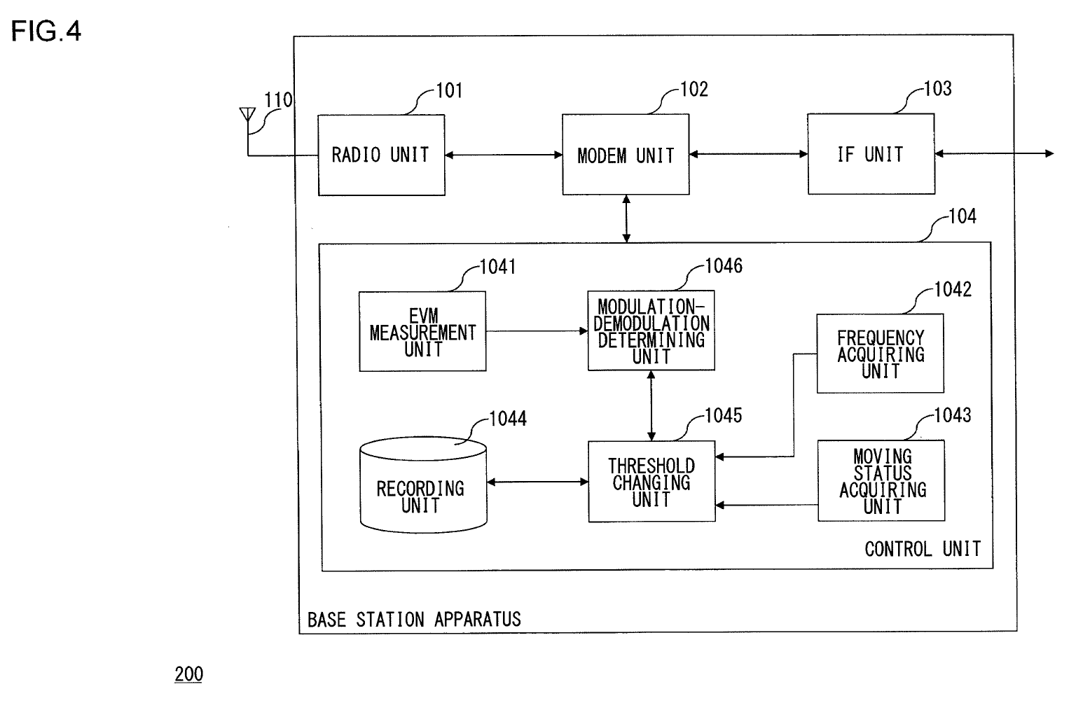

FIG. 4 is a conceptual diagram showing a structure of the base station apparatus 1 of FIG. 3. In FIG. 4, an antenna 110 transmits and receives radiofrequency signals.

As a receiving operation, a radio unit 101 performs frequency conversion on the radiofrequency signals received by the antenna 110 so as to derive baseband signals, and outputs the baseband signals to a modem unit 102. As a transmission operation, the radio unit 101 performs frequency conversion on the baseband signals inputted from the modem unit 102 and thereby derives radiofrequency signals. Note that the baseband signal is composed of in-phase components and quadrature components. For the simplicity of figure, those are presented here by a single signal line only in FIG. 4. An AGC (Auto Gain Control) unit and an A/D (Analog/Digital) conversion unit are also included in the radio unit 101.

As a receiving operation, the modem unit 102 demodulates the input received from the radio unit 101 and outputs it to an IF unit 103. As a transmission operation, the modem unit 102 outputs the modulated signals to the radio unit 101. The π/2-shift BPSK (Binary Phase Shift Keying), π/4-shift BPSK, D8PSK (Differential 8 Phase Shift Keying), 16-QAM (Quadrature Amplitude Modulation), 32-QAM, 64-QAM or the like is used as the modulation scheme.

The IF unit 103 is connected to a not-shown network. As a receiving operation, the IF unit 103 outputs the signals demodulated by the modem unit 102, to the not-shown network. Also, as a transmission operation, the IF unit 103 receives the input of data from the network and outputs the received data to the modem unit 102.

A control unit 104 controls the timing and the like of the base station apparatus 1 as a whole. Also, if a request signal for retransmission of data (NACK: Negative Acknowledge) is contained in the signals demodulated by the modem unit 102, the control unit 104 will perform retransmission control of data in basic units of PDU (Protocol Data Unit) of a MAC layer stored in the PayLaod of FIG. 2. An example of such retransmission control includes Go-Back-N ARQ (Automatic Repeat Request).

The control unit 104 includes an EVM measurement unit 1041, a frequency acquiring unit 1042, a moving status acquiring unit 1043, a recording unit 1044, a threshold modifying unit 1045, and a modulation-demodulation determining unit 1046. The control unit 104 determines a modulation/demodulation scheme suitable for a propagation environment.

The EVM measurement unit 1041 measures the distance between the coordinate point of a known signal demodulated by the modem unit 102 and that of an ideal known signal on the plane of I-Q coordinates.

Further, the EVM measurement unit 1041 averages the measured EVMs between frames so as to derive an MSE. In the inter-frame averaging which reduces the effect of external disturbances, a forgetting factor λ of 1 or less is predetermined and an average value is weighted with this forgetting factor λ so as to perform the processing of weighted moving average processing.

To change the modulation scheme, the frequency acquiring unit 1042 detects the frequency at which control signals are transmitted to and received from the terminal apparatus 2, in a predetermined period of time. The control signals associated with the change of the modulation scheme include a request signal for the switching of modulation scheme, an instruction signal for instructing the switching of modulation scheme, an idle burst and so forth.

To retransmit the data, the frequency acquiring unit 1042 also detects the frequency at which control signals are transmitted to and received from the terminal apparatus 2, in a predetermined period of time. The control signals associated with the retransmission of data include a request signal for the retransmission of data, a signal for storing data to be retransmitted (the whole of or part of PDU used to request the retransmission) and so forth.

Here, to detect the frequency at which the control signals are transmitted and received as a result of data retransmission, the frequency acquiring unit 1042 may detect the error using CRC contained in the received data and thereby derive the number of errors that have occurred in a predetermined period of time. In this case, the frequency acquiring unit 1042 records beforehand the correspondence between the number of errors and the frequency at which the control signals are transmitted and received as a result of data retransmission, in the recording unit 1044 (described later) as a table, and derives the frequency at which the control signals are transmitted and received as a result of data transmission, by referencing this table.

The moving status acquiring unit 1043 detects the moving velocity of the terminal apparatus 2. The moving status acquiring unit 1043 measures the absolute values of phase differences on the time axis, about the known signals received from the terminal apparatus 2, and derives the error of the phase differences from the absolute values of the phase differences measured for a plurality of known signals. The moving status acquiring unit 1043 records beforehand a correspondence between error values and moving velocities, in the recording unit 1044 (described later) as a table and derives the moving velocity from the error values by referencing this table. If the terminal apparatus 2 is equipped with a GPS (Global Positioning System), the moving status acquiring unit 1043 may acquire positional information from the terminal apparatus 2 and derive the moving velocity from this positional information.

The moving status acquiring unit 1043 also detects the variation situation in positional relationship between the base station apparatus 1 and the terminal apparatus 2. The moving status acquiring unit 1043 measures a displacement of receive timing of the known signals received from the terminal apparatus 2, and determines that the terminal apparatus 2 is moving away from the base station 1 if the receive timing is slow and determines that the terminal apparatus 2 is approaching if the receive timing is fast. In this manner, the moving status acquiring unit 1043 derives the variation situation in positional relationship between the base station apparatus 1 and the terminal apparatus 2. If the terminal apparatus 2 is equipped with a GPS, the moving status acquiring unit 1043 may acquire positional information from the terminal apparatus 2 and derive the variation situation in positional relationship between the base station apparatus 1 and the terminal apparatus 2, from this positional information.

In addition to the above-described table, the recording unit 1044 records a correspondence between the MSE derived by the EVM measurement unit 1041 and a modulation scheme used for the next communication, as another table (hereinafter referred as “modulation-scheme table”). Also, if the threshold modifying unit 1045 adds an offset value for the purpose of changing a threshold value in the modulation-scheme table, the recording unit 1044 will record the offset value and the terminal identification information of the terminal apparatus 2 to be communicated (PS-ID, for instance) by associating the offset value with the terminal identification information thereof.

The threshold modifying unit 1045 references two different pieces of information so as to determine whether the threshold value in the modulation-scheme table is to be changed or not. Here, one of the two different pieces of information referenced is the information, acquired by the frequency acquiring unit 1042, on the frequency at which the control signals are transmitted to and received from the terminal apparatus 2 (the change frequency of modulation schemes and the occurrence frequency of data retransmission). The other of the two different pieces of information referenced is the information, acquired by the moving status acquiring unit 1043, on the moving status of the terminal apparatus 2 (the moving velocity of the terminal apparatus 2 and the variation situation in positional relationship between the base station apparatus 1 and the terminal apparatus 2).

As the change frequency of modulation schemes and the occurrence frequency of data retransmission increase, the total number of transmitting and receiving the control signals to and from the terminal apparatus 2 increases and consequently the time available for data transmission and data receiving becomes less and less. Thus, in order to suppress the frequent change of modulation schemes and the frequent occurrence of data retransmission, the threshold modifying unit 1045 modifies the threshold value in such a manner that a highly reliable modulation scheme, namely a modulation scheme having a smaller multi-level number, is more likely to be selected, when the change frequency of modulation scheme and the occurrence frequency of data retransmission are high.

As the moving velocity of the terminal apparatus 2 becomes smaller, the fading effect due to the Doppler shift becomes less, for instance. Although, in this manner, an improvement in the propagation environment may be expected when the moving velocity thereof gets smaller, the moving velocity of the terminal apparatus 2 is not necessarily reflected in the measured results of EVM. Thus, in order to select, if at all possible, a modulation scheme having a larger transmission amount, the threshold modifying unit 1045 modifies the threshold value in such a manner that a modulation scheme having a larger multi-level number is more likely to be selected, if the moving velocity of the terminal apparatus 2 is small.

As the terminal apparatus 2 approaches, the received electric field strength becomes larger and therefore an improvement of the propagation environment may be expected. However, the variation situation in positional relationship between the base station apparatus 1 and the terminal apparatus 2 is not necessarily reflected in the measured results of EVM. Thus, in order to select, if at all possible, a modulation scheme having a larger transmission amount, the threshold modifying unit 1045 modifies the threshold value in such a manner that a modulation scheme having a larger multi-level number is more likely to be selected, if the terminal apparatus 2 approaches.

When changing the threshold value, the threshold modifying unit 1045 adds the offset value to the threshold value in the modulation-scheme table and then outputs the threshold value added with the offset value to the modulation-demodulation determining unit 1046. Then whether the thus determined modulation scheme has been used or not is verified by referencing the modified modulation-scheme table for the duration of a predetermined period of time or longer (over a prescribed number of frames or more, for instance). If it is verified that the thus determined modulation scheme has been used, the offset value and the identification information of the terminal apparatus 2 to be communicated will be recorded in the recording unit 1044 by associating them with each other.

Immediately after the start of communication with the terminal apparatus 2, the threshold modifying unit 1045 acquires the terminal identification information of the terminal apparatus 2 and verifies if the offset value corresponding to said terminal identification information is recorded in the recording unit 1044. If the offset value is recorded therein, the threshold modifying unit 1045 will receive the corresponding offset value from the recording unit 1044, add this offset value to the threshold value in the modulation-scheme table and output the threshold value added with this offset value to the modulation-demodulation determining unit 1046. Thereby, the moment the communication starts, a modulation scheme suitable for the terminal apparatus 2 can be selected.

When determining if the threshold value in the modulation-scheme table is to be modified, the threshold modifying unit 1045 does not have to reference all of factors which are the change frequency of modulation schemes, the occurrence frequency of data retransmission, the moving velocity of the terminal apparatus 2, and the variation situation in positional relationship between the base station apparatus 1 and the terminal apparatus 2. The threshold modifying unit 1045 may reference only one of these factors or reference any of them in arbitrary combination. Or the threshold modifying unit 1045 may reference them by prioritizing them. If only one of them is referenced, the selection of a modulation scheme suitable for a propagation environment can be simplified. If any of them in arbitrary combination are to be referenced, a modulation scheme suitable for a propagation environment can be selected flexibly. If 1) the occurrence frequency of data retransmission, 2) the change frequency of modulation schemes, 3) the variation situation in positional relationship between the base station apparatus 1 and the terminal apparatus 2, and 4) the moving velocity of the terminal apparatus 2 are referenced by prioritizing these factors in this order, whether selecting a modulation scheme having a small multi-level number is led to a more preferable communication state or not will be determined first. Then whether selecting a modulation scheme having a large multi-level number is led to a more preferable communication state or not will be determined. Hence, the modulation scheme suitable for the propagation environment can be selected while the reliability is improved.

The modulation-demodulation determining unit 1046 receives a modulation-scheme table corresponding to the previous modulation scheme, from the threshold modifying unit 1045 and determines a modulation scheme of the next communication from the MSE derived by the EVM measurement unit 1041 by referencing this table so as to control the modem unit 102.

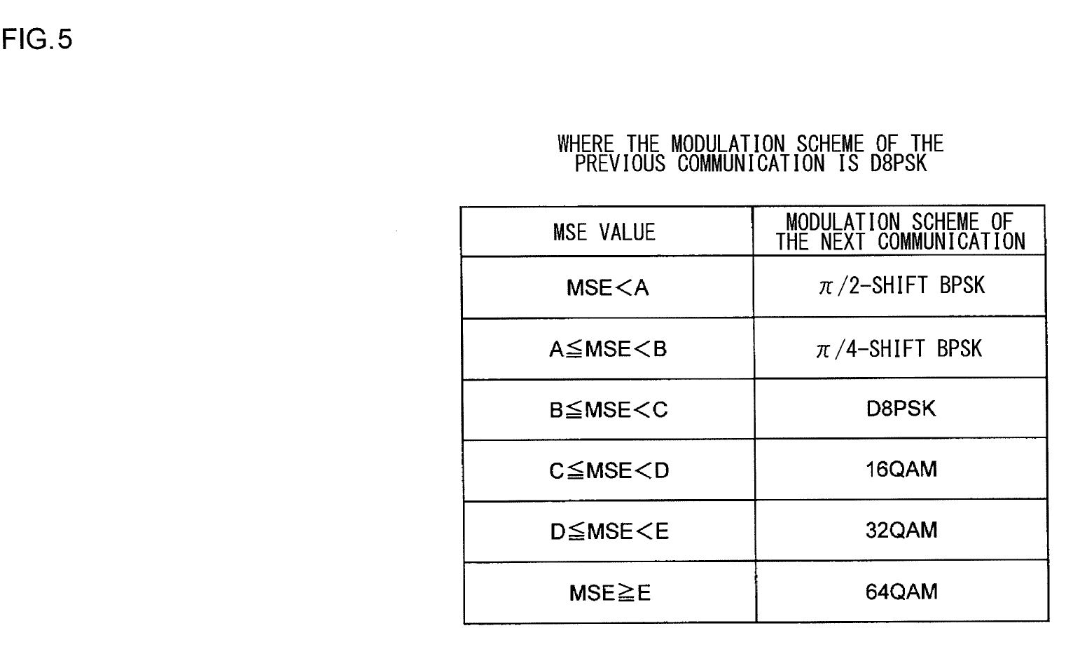

FIG. 5 is a data structure of a modulation-scheme table where the modulation scheme of the previous communication is D8PSK. In FIG. 5, MSE is divided into six ranges, and the threshold values A to E used to specify the six ranges are defined such that A>B>C>D>E. In FIG. 5, a range, corresponding to “MSE<A”, where MSE is less than A is a range where MSE is minimum. Further, “A≦MSE<B”, “B≦MSE<C”, “C≦MSE<D”, “D≦MSE<E”, and “MSE≧E” are ranges each of which MSE becomes larger in this order.

In the table of FIG. 5, six modulation schemes of “π/2-shift BPSK” through “64-QAM” are associated with the six ranges of MSE. For example, according to this table, “32-QAM” is assigned, as the modulation scheme of the next communication, if MSE is in the range of “D≦MSE<E”.

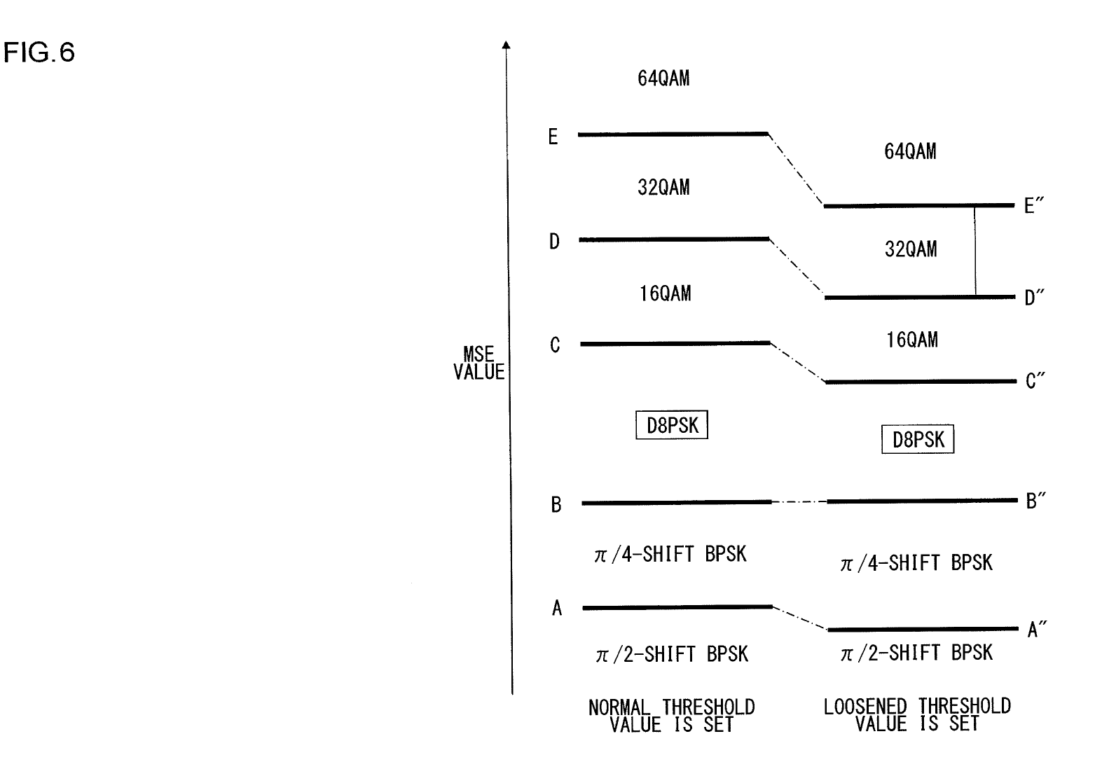

FIG. 6 is a conceptual diagram showing a transition of threshold values, relative to the modulation-scheme table of FIG. 5, in a case where offset values are added in such a manner that a modulation scheme having a larger multi-level number is more likely to be selected. When the threshold values are loosely set so that a modulation scheme having a larger multi-level number may be more likely to be selected, the modified threshold values (indicated by “A′” to “E′” in FIG. 6) become smaller than those before the modification (indicated by “A” to “E” in FIG. 6). The threshold modifying unit 1045 adds each predetermined offset value for each threshold value, namely subtracts each predetermined offset value from each threshold value. That is, each modified threshold value is set such that each modified threshold value becomes smaller than that before modification. In doing so, each different offset value may be subtracted from each threshold value or the same offset value may be subtracted from each threshold value. Suppose that the offset value is subtracted in a manner that the larger the threshold value is, the larger the offset value will be subtracted therefrom. In this case, an MSE range corresponding to a modulation scheme having larger multi-level number has a smaller lower limit threshold value and therefore even in a small MSE a modulation scheme having a large multi-level number is more likely to be selected. If, on the other hand, the same offset value is subtracted from each threshold value, it is only necessary for the recording unit 1044 to record a single offset value and therefore the efficiency of offset-value recording is improved.

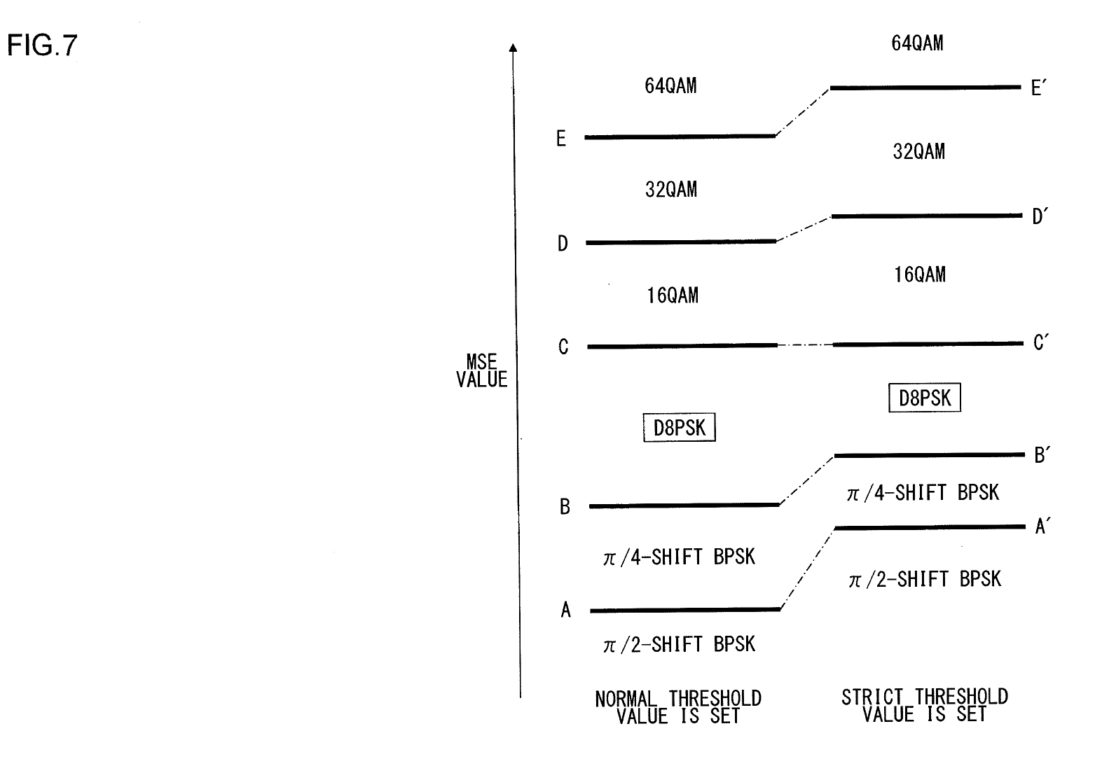

FIG. 7 is a conceptual diagram showing a transition of threshold values, relative to the modulation-scheme table of FIG. 5, in a case where offset values are added in such a manner that a modulation scheme having a smaller multi-level number is more likely to be selected. When the threshold values are strictly set so that a modulation scheme having a smaller multi-level number may be more likely to be selected, the modified threshold values (indicated by “A″” to “E″” in FIG. 7) become larger than those before the modification (indicated by “A” to “E” in FIG. 7). The threshold modifying unit 1045 adds each predetermined offset value for each threshold value so as to set each modified threshold value such that each modified threshold value becomes larger than that before modification. In doing so, each different offset value may be added to each threshold value or the same offset value may be added each threshold value. Suppose that the offset value is added in a manner that the larger the threshold value is, the larger the offset value will be added thereto. Then an MSE range corresponding to a modulation scheme having larger multi-level number has a larger lower limit threshold value. Thus a modulation scheme having a smaller multi-level number is more likely to be selected, whereas a modulation scheme having a larger multi-level number is less likely to be selected. If, on the other hand, the same offset value is added to each threshold value, it is only necessary for the recording unit 1044 to record a single offset value and therefore the efficiency of offset-value recording is improved.

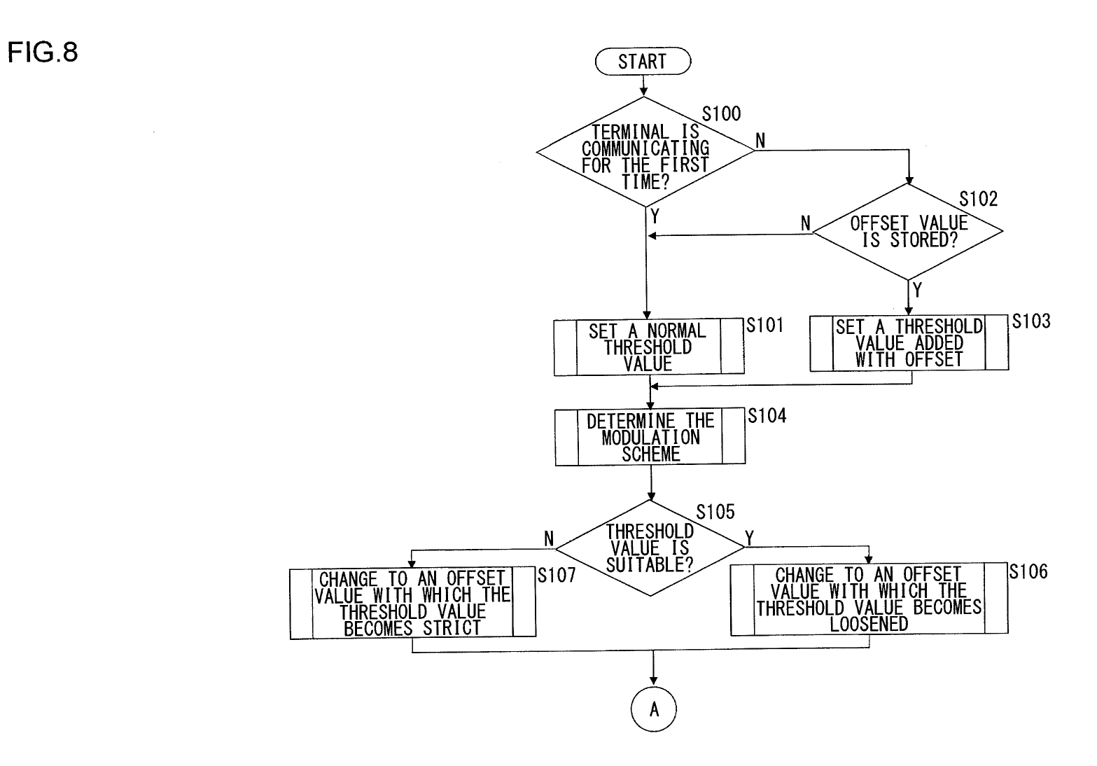

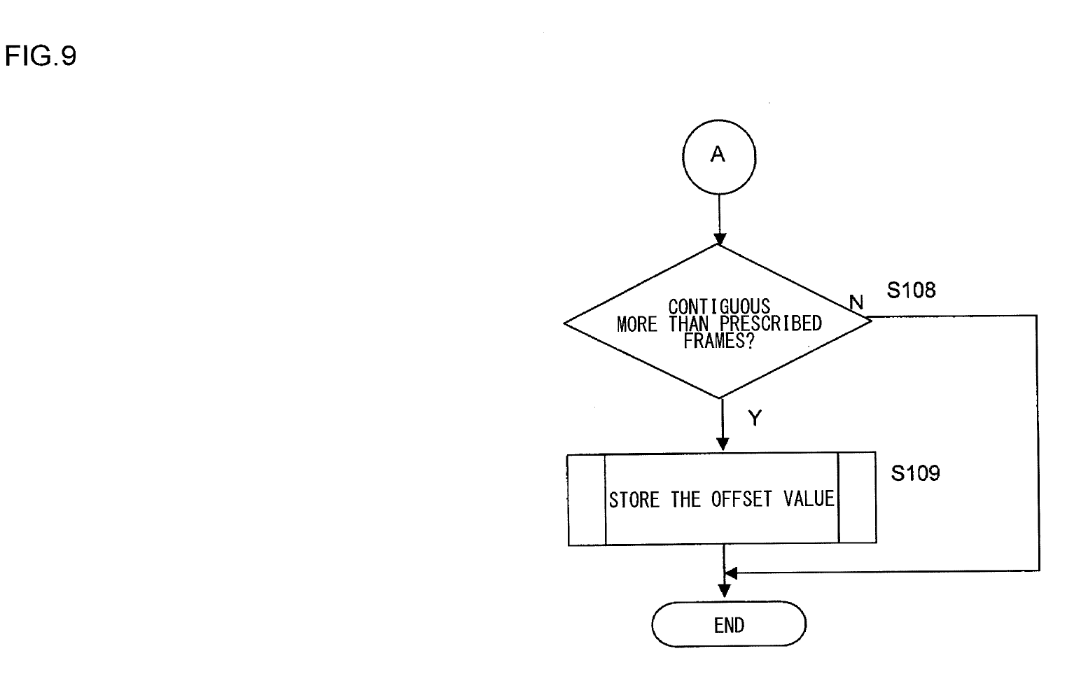

FIG. 8 and FIG. 9 are each a flowchart showing a procedure for modifying the threshold values. The control unit 104 acquires the terminal identification information of a terminal apparatus 2 to be communicated, and verifies if the terminal apparatus 2 is communicating with the base station apparatus 1 for the first time or not (S100).

If the terminal apparatus 2 is communicating with the base station apparatus 1 for the first time (Y of S100), the threshold modifying unit 1045 will read out a modulation-scheme table corresponding to the current modulation scheme, from the recording unit 1044 and output the modulation-scheme table to the modulation-demodulation determining unit 1046 (S101). If the base station apparatus 1 did communicate with this terminal apparatus 2 in the past (N of S100), the threshold modifying unit 1045 will receive the terminal identification information from the control unit 104 and verify if an offset value associated with the terminal identification information is recorded in the recording unit 1044. If the offset value associated therewith is recorded (Y of S102), the threshold modifying unit 1045 will read out both a modulation-scheme table corresponding to the current modulation scheme and the offset value from the recording unit 1044, add the offset value to a threshold value in the modulation-scheme table and output the threshold value added with the offset value to the modulation-demodulation determining unit 1046 (S103).

The modulation-demodulation determining unit 1046 references the modulation-scheme table received from the threshold modifying unit 1045 and then determines the next modulation scheme based on the MSE derived by the EVM measurement unit 1041 (S104).

While referencing the information, acquired by the frequency acquiring unit 1042, on the frequency at which the control signals are transmitted to and received from the terminal apparatus 2 and the information, acquired by the moving status acquiring unit 1043, on the moving status of the terminal apparatus 2, the threshold modifying unit 1045 determines whether the threshold value in the modulation-scheme table is appropriate or not (S105). If a modulation scheme having a larger multi-level number is to be easily selected in accordance with the propagation environment (Y of S105), the offset value will be changed to an offset value with which the threshold value is loosened, the offset value will be added to the threshold value in the modulation-scheme table, and the threshold value added with the offset value will be outputted to the modulation-demodulation determining unit 1046. If a modulation scheme having a smaller multi-level number is to be easily selected (N of S105), the offset value will be changed to an offset value with which the threshold value is strict, the offset value will be added to the threshold value in the modulation-scheme table, and the threshold value added with the offset value will be outputted to the modulation-demodulation determining unit 1046.

If the same modulation scheme has been used over a prescribed number of frames or more (Y of S108) and an offset value has been added in a modulation-scheme table corresponding to said modulation scheme, the threshold modifying unit 1045 will record said offset value in the recording unit 1044 by associating said offset value with the terminal identification information (S109).

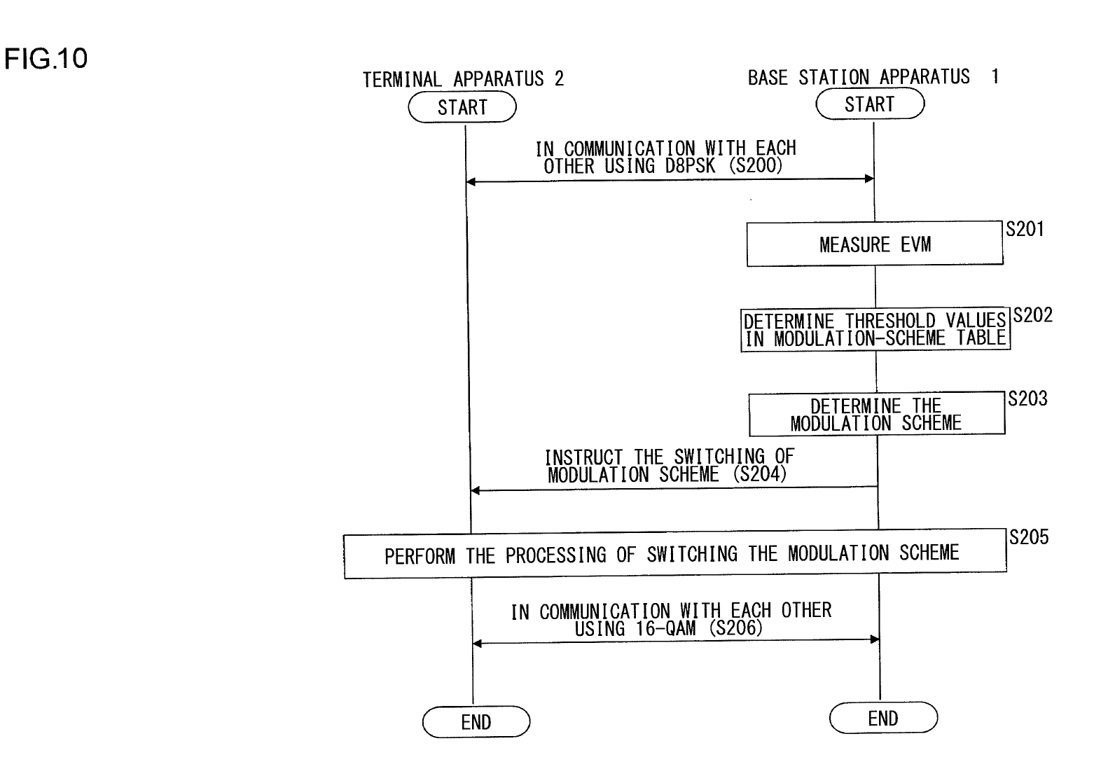

An operation of the communication system 100 structured as above will now be explained. FIG. 10 is a sequence diagram showing a processing of changing a modulation scheme led by the base station apparatus 1. The base station apparatus 1 and the terminal apparatus 2 communicate with each other using D8PSK (S200). The EVM measurement unit 1041 measures the EVM so as to derive the MSE (S201). While referencing the information on the frequency at which the control signals are transmitted to and received from the terminal apparatus 2 and the information on the moving status of the terminal apparatus 2, the threshold modifying unit 1045 determines threshold values in a modulation-scheme table corresponding to D8PSK (S202). The modulation-demodulation determining unit 1046 determines the use of 16-QAM as the next modulation scheme, based on the MSE value (S203). Then the modulation-demodulation determining unit 1046 instructs the terminal apparatus 2 to switch the modulation scheme (S204).

Both the terminal apparatus 2, which has received the instruction, and the base station apparatus 1 perform the processing of switching the modulation scheme wherein this switching processing includes a processing of resynchronization (S205). After this, the base station apparatus 1 and the terminal apparatus 2 communicate with each other using 16-QAM (S206).

By employing the embodiments of the present invention as described above, the operation performed and the effects achieved thereby are as follows.

(1) The EVM measurement unit 1041 measures the EVM of received signals and performs a weighted average on them so as to derive MSE. The frequency acquiring unit 1042 acquires the change frequency of modulation scheme and the occurrence frequency of data retransmission. The moving status acquiring unit 1043 acquires the variation situation in moving velocity of the terminal apparatus or positional relationship between the base station apparatus and the terminal apparatus. The threshold modifying unit 1045 determines the modulation scheme used for the next communication, based on the value of MSE and the other pieces of information described above. As a result, the modulation scheme suited to the propagation environment can be accurately selected.

(2) When the change frequency of modulation scheme and the occurrence frequency of data retransmission are high, the threshold modifying unit 1045 modifies the threshold values in the modulation-scheme table in such a manner that a modulation scheme having a smaller multi-level number is more likely to be selected. As a result, a highly reliable modulation scheme is more likely to be selected and the transmission efficiency is improved.

(3) When the moving velocity of a terminal apparatus is small and/or when the terminal apparatus approaches, the threshold modifying unit 1045 modifies the threshold values in the modulation-scheme table in such a manner that a modulation scheme having a larger multi-level number is more likely to be selected. As a result, a modulation scheme capable of transmitting a larger amount of information is more likely to be selected and the transmission rate is increased.

The description of the invention given above is based upon illustrative embodiments. The present invention is thus not limited to the structures and components of the embodiments and are within the applicable range of the present invention defined by WHAT IS CLAIMED. Also, various modifications could be developed if the functions derived from the structure and components of the above-described embodiments are achievable.

For example, in the present embodiments, a description has been given of a case where TDMA is used in the communication system 100. However, this should not be considered as limiting and TDMA and CDMA (Code Division Multiple Access) may be used in the communication system 100. Also, TDMA and OFDMA (Orthogonal Frequency Division Multiple Access) may be used or wireless LAN (Local Area Network) such as IEEE802.11n may be used in the communication system 100.

### INDUSTRIAL APPLICABILITY

The present invention determines a modulation scheme to be used, in consideration of not only the quality of received signals but also the frequency at which control signals are transmitted to and received from a terminal apparatus, and so forth. Thus the modulation scheme suited to the propagation environment can be accurately selected.

1. A base station apparatus, comprising:
a communication unit configured to communicate with a terminal apparatus;
a first acquiring unit configured to acquire first information related to the quality of signal received by the communication unit;
a second acquiring unit configured to acquire second information related to the change frequency of modulation scheme or the occurrence frequency of data retransmission between the base station apparatus and the terminal apparatus in a predetermined period of time;
a third acquiring unit configured to acquire third information related to the moving status of the terminal apparatus; and
a selector configured to select a modulation scheme used in a communication between the base station apparatus and the terminal apparatus, based on at least one of the first information, the second information and the third information.

2. A base station apparatus according to claim 1, wherein the selector selects the modulation scheme used in a communication between the base station apparatus and the terminal apparatus, based on the first information and the second information.

3. A base station apparatus according to claim 1, wherein the third acquiring unit acquires the variation situation in moving velocity of the terminal apparatus or positional relationship between the base station apparatus and the terminal apparatus, as the third information.

4. A base station apparatus according to claim 1, further comprising a modifying unit configured to modify a threshold value related to the first information, based on the second or third information,
wherein the selector selects a modulation scheme used in a communication between the base station apparatus and the terminal apparatus, based on a result of comparing the first information against the threshold value.

5. A base station apparatus according to claim 4, wherein when it is determined that a modulation scheme having a multi-level number smaller than that of the selected modulation scheme is suitable for a communication between the base station and the terminal apparatus, the modifying unit modifies the threshold value in such a manner that the modulation scheme having a smaller multi-level number is more likely to be selected in the selector, and
wherein when it is determined that a modulation scheme having a multi-level number larger than that of the selected modulation scheme is suitable for the communication between the base station and the terminal apparatus, the modifying unit modifies the threshold value in such a manner that the modulation scheme having a larger multi-level number is more likely to be selected in the selector.
